(19) United States
(12) Patent Application Publication
(10) Pub. No.: US 2008/0193246 A1
(43) Pub. Date: Aug. 14, 2008

(54) Remotely Controlled Twist-Lock and a Method For Controlling Such a Lock to be Connected to a Container

(75) Inventors: Hans Bohman, Stockholm (SE); Karl Bohman, Bromma (SE)

Correspondence Address: HARNESS, DICKEY & PIERCE, P.L.C., P.O. BOX 8910, RESTON, VA, 20195, US

(73) Assignee: ALL SET MARINE LASHING AB, BROMMA (SE)

(21) Appl. No.: 11/661,324

(22) PCT Filed: Sep. 2, 2005
(86) PCT No.: PCT/SE05/01275

§ 371 Date: Aug. 21, 2007

Related U.S. Application Data
(60) Provisional application No. 60/607,179, filed on Sep. 3, 2004.
(60) Provisional application No. 60/639,759, filed on Dec. 28, 2004.

(51) Int. Cl. B60P 7/13

(52) U.S. Cl. 410/82

(57) ABSTRACT

The present invention relates to a twist-lock (104a-d) and a method for controlling a twist-lock to be connected to a container (102) for locking two containers together. The method comprises to match the remotely controlled twist-lock (104a-d) with the container (102), wherein unique identifiers are registered for said twist-lock and said container, storing said identifier information in a database. Further the unlocking function of said twist-lock is remotely controllable by means of a remote control unit (104).

### RELATED APPLICATIONS

The full utility patent application of this application will cross-reference and incorporate by reference the entire disclosure of U.S. patent application Ser. No. 10/667,282 filed on Sep. 17, 2003, as well as U.S. Patent Application No. 60/607,179 filed on Sep. 3, 2004.

### TECHNICAL FIELD

The present invention relates to a twist-lock and a method for controlling a twist-lock to be connected to a container for locking two containers together.

### BACKGROUND ART

Twist-locks typically used today for inter-modal shipping containers (“containers”) are generally spring-loaded devices that are of the positively-biased type. The term “positively-biased twist-lock” refers to those twist-locks having a handle or other mechanism that, when activated, releases stored energy, meaning that, when, for example, a handle of the twist-lock is pulled, stored energy of the twist-lock spring causes the twist-lock to move into a position that locks two containers together. It may be seen that, in order to move multiple containers at the same time without exceeding the IMO multiple-container weight requirements, present-day twist-locks need to be manually unlocked at strategic locations on, for example, the deck of a ship.

The manual unlocking of conventional positively-biased twist-locks is both time-consuming and labor-intensive. For example, a stevedore must manually unlock each twist-lock by pulling a handle or the like. In the event that an interface between two locked-together containers is located above the top of a bottom container of a stack, the stevedore must climb to the level of the interface or use a pole or other apparatus to manually unlock the two containers at each twist-lock location. It is apparent that such a procedure is inefficient, expensive, and involves significant risk to the stevedore. In addition, in the event that a handle or analogous release mechanism is missing or damaged, the twist-lock can oftentimes not be manually unlocked without additional procedures being performed.

Further, if, for example, six containers are stacked on top of one another on a ship deck and locked together with twist-locks, the containers would need to be stacked so the maximum number of successive containers could be unloaded at one time without exceeding the IMO multiple-container weight requirements. If the six containers were to be unloaded three at a time, each of: 1) the top three containers; and 2) the bottom three containers would need to not exceed a collective total weight of 20 tons. This means that the loaded weight of each container and the sequence in which the containers are stacked on top of one another must be considered during the loading process in order to maximize efficiency and avoid exceeding IMO requirements.

Conventional twist-locks often include a flange that creates a space between the two locked containers. A handle that is used to lock or unlock the twist-lock is disposed in the flange space. Conventional twist-locks are not generally used in the holds of ships because it is usually not possible to reach the handle in order to unlock the twist-locks when the containers are stacked in a cell guide structure in the hold. Even if it were possible to reach the handle, it would not be desirable to use twist-locks in the holds because of the thickness of the flange, which adds vertical space between stacked containers. Today, stackers with at most approximately 10-12 mm thick flanges are sometimes currently used in the holds. While the currently-used stackers fulfill necessary strength requirements, they do not serve to lock containers to one another.

It would be an advantage to provide a system for using twist-locks in the holds, particularly if remotely controlled actuation systems were included.

### SUMMARY OF THE INVENTION

An object of the present invention is to provide a efficient and easily handled twist-lock and method for fastening of containers.

The above object and other objects that will be evident from the following description are achieved by a method and a twist-lock to be connected to a corner fitting of a container according to the appended claims.

According to one aspect of the invention a method is provided for controlling a twist-lock to be connected to a container for locking two containers together comprising the steps of:
matching the remotely controlled twist-lock with the container, wherein unique identifiers are registered for said twist-lock and said container;
storing said identifier information in a database.

Preferably the method further comprises the step of:
selectively remote unlocking of the twist-locks for unlocking of the containers from each other.

Furthermore the method according to the inventive concept comprises the step of:
entering data to said database to be associated with said identifier, for example the loaded weight of said container.

Moreover it is preferred by the method to further comprise the step of:
programming a security device, to be mounted on the container, with the identifiers of said twist-lock.

Preferably the method comprises the step of:
transmitting identifiers from said twist-lock and said security device to a remote server.

It will be appreciated by a person skilled in the art that said method can be provided for creating a discharge plan to be saved on a memory stick and used by a remote control unit for controlling said twist-lock.

Moreover it is preferred that the method according to the inventive concept further comprises the step of:
daisy chaining wherein the unlock command from a first twist-lock is passed along from container to container until it reaches its destination.

In a preferred embodiment, the twist-lock for connection to a container for locking two containers together, wherein the unlocking function of said twist-lock is remotely controllable by means of a remote control unit.

Preferably the twist-lock is provided with an identifier to be associated with an identifier of the container.

Moreover a particular twist-lock is identifiable, which permits selective remote unlocking of the twist-lock via a radio interface.

Furthermore said remote control unit is connectable to a antenna for enhancing the communication between said twist-lock and said remote control unit.

It will be appreciated by a person skilled in the art that the twist-lock is flangeless, i.e. without adding unnecessary vertical height between the containers.

### BRIEF DESCRIPTION OF THE DRAWINGS

A more complete understanding of the present invention may be obtained by reference to the following Description, when taken in conjunction with the accompanying Drawings, wherein:

FIG. 1 illustrates an exemplary process for matching remotely-controlled twist-locks with an inter-modal container, firstly four twist-lock id is read, thereafter the container safety device (optional) is programmed and finally the match is sent to TOS.

FIG. 2 illustrates an overview of a programming embodiment for a remotely-controlled twist-lock (RCT). From the load plan (sequence) the container to be loaded Is selected and the twist-lock is programmed with the container number. The twist-lock and container numbers are stored in, the load database.

FIG. 3 illustrates a container-unloading scenario

FIG. 4 shows how programming of the container number in to the twist-lock is done when installing the twist-locks prior to loading (coning).

FIG. 5 shows a discharge plan created in the ships load computer, i.e. a list is generated with all the container numbers to be discharged. This plan is then saved on a memory stick and inserted in the RCAP.

FIG. 6 illustrates how one twist-lock of four is enough to unlock all twist-locks via ad hoc networking capability.

FIG. 7 If a container will not unlock you can select “enhance range” from the remote control unit menu. This will trigger the remote control unit to start “daisy-chaining” the unlock command from one twist-lock to another until it reaches its “destination”.

FIG. 8 illustrates an aspect of the twist-lock actuation system, showing the remote control unit being used together with an RCAP and/or antenna.

FIG. 9 shows the twist-lock actuation system being used together with a crane in a harbor.

### DETAILED DESCRIPTION OF PREFERRED EMBODIMENTS

The invention will now for the purpose of exemplification be described in more detail by means of examples and with reference to the accompanying drawings.

A twist-lock 104a-d in accordance with various embodiments of the invention is a twist-lock in which a lifting force from a container crane can be used for locking and unlocking the twist-lock. The twist-lock 104a-d may be used in combination with, for example, a radio receiver and a solenoid to remotely control release of the stored energy of the spring. When the twist-lock is remotely actuated, the twist-lock unlocks without any additional manual intervention.

A twist-lock 104a-d in accordance with various embodiments of the invention is flangeless, or has only a very thin (e.g., 10-12 mm) flange for disposition of an antenna near thereto. There is typically approximately 10 mm vertical clearance in a twist-lock. A lifting force from a crane can be used in accordance with various embodiments of the invention for locking or unlocking the twist-lock within this clearance.

Identification of a particular twist-lock 104a-d permits selective remote unlocking of the twist-lock via a radio interface. A radio receiver together with, for example, a solenoid or servo or nanomuscle, may be used to control when the lifting force from the container crane may lock or unlock the twist-lock. In this manner, particular twist-locks can be unlocked from a remote location in order to facilitate more efficient VTL. Once selective remote unlocking of the twist-locks has occurred, multiple containers 102 can be moved together without the necessity of manual unlocking of the twist-locks by a stevedore. Of course, placement of the twist-locks on the containers by a stevedore is still necessary.

Twist-locks 104a-d constructed in accordance with various embodiments of the invention may thus be unlocked from a remote location, eliminating the need for the handle flange typical of conventional twist-locks. Elimination of twist-lock handle flanges results in flangeless twist-locks, which can consume less vertical space than conventional twist-locks and therefore facilitate their use in the holds of ships where multiple containers 102 may be locked together and handled more efficiently.

The use of flangeless twist-locks 104a-d with a remote unlocking system in accordance with embodiments of the present invention may permit containers to be selectively unlocked from one another and moved. This may be done without adding unnecessary vertical height required for conventional twist-locks that would reduce the capacity of contained storage in the ship's hold.

In an embodiment of the present invention, a handheld or stationary reader 104 is used to selectively unlock remotely-controlled twist-locks as described in more detail below. The reader 104 may or may not be the RCU described below. The handheld or stationary reader may also be used in connection with a container security device 106 and associated system hardware and software as described in more detail in U.S. patent application Ser. No. 10/667,282. It should be noted, however, that various embodiments of the invention may be employed with or without the container security device 106 and associated hardware and software as described in U.S. patent Ser. No. 10/667,282. For example, the loaded weight of containers may be entered into the reader 104 at the time of, or shortly after, sealing the container via the container security device. As another example, the handheld reader may be used to selectively remotely unlock particular containers from one another.

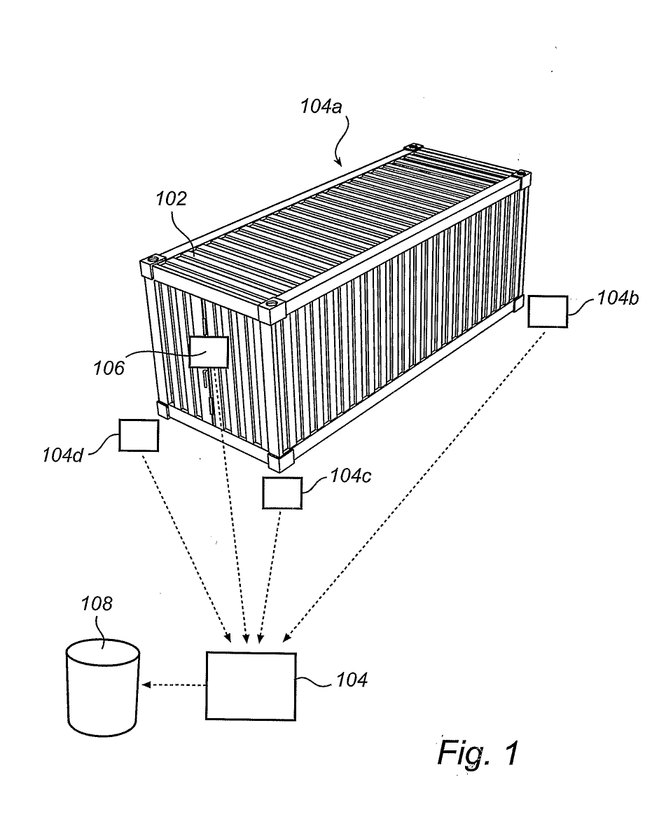

Referring now to FIG. 1, there is shown an exemplary process for matching the remotely-controlled twist-locks 104a-104d with an inter-modal container (“container”) 102. It will be apparent to those having ordinary skill in the art that the remotely-controlled twist-locks 104a-104d may be used to lock the container 102 to another container disposed there beneath after the container 102 has been placed on top of another container. Only the remotely-controlled twist-locks 104b-104d are shown in FIG. 1. The remotely-controlled twist-lock 104a is obscured by the container 102 in this particular view. As indicated above, the remotely-controlled twist-locks 104a-104d and the reader 104 may be used with or without the container security device 106.

The reader 104 is illustrated as a stationary reader that may be installed on a crane (e.g., spreader). In various embodiments of the invention, the reader 104 may read an identifier of the container 102 as well as the total weight thereof. The reader 104 may also be used to associate identifiers of each of the remotely-controlled twist-locks 104a-104d with an identifier of the container 102. In addition, the container security device 106 may be used to store the identifier of the container 102 as well as the total weight thereof.

Still referring to FIG. 1, a process of one embodiment of the invention is shown. Step 1 of the process includes the matching of the remotely-controlled twist-locks 104a-104d with the container 102, wherein unique identifiers of each of the remotely-controlled twist-locks 104a-104b are read by a handheld reader 104. This process is illustrated by dashed lines from each of the remotely-controlled twist-locks 104b-104d and a box located on a dashed line between the handheld reader 104 and the remotely-controlled twist-lock 104b.

In a second step of the matching process, a container security device 106 to be mounted on the container 102 is programmed with the identifiers of the remotely-controlled twist-locks 104b-104d obtained during step 1. The programming step (i.e., step 1) is indicated by another box located on a dashed line between the handheld reader 104 and the container security device 106.

In a third step of the matching process, data linking an identifier of the container security device 106 and the identifiers of each of the remotely-controlled twist-locks 104a-104d is transmitted to a remote server 108 in the form of a Terminal Operator System (TOS). The third step is indicated by a dashed line between the handheld reader 104 and the remote server 108 and a third box.

Although FIG. 1 illustrates use of the remotely-controlled twist-locks 104a-104d with the container security device 106, it will be appreciated by those having ordinary skill in the art that a matching process may be undertaken with or without the container security device 106. In addition, although four remotely-controlled twist-locks are shown in FIG. 1 and elsewhere in this patent application, more or less than four remotely-controlled twist-locks may be utilized without departing from principles of the invention.

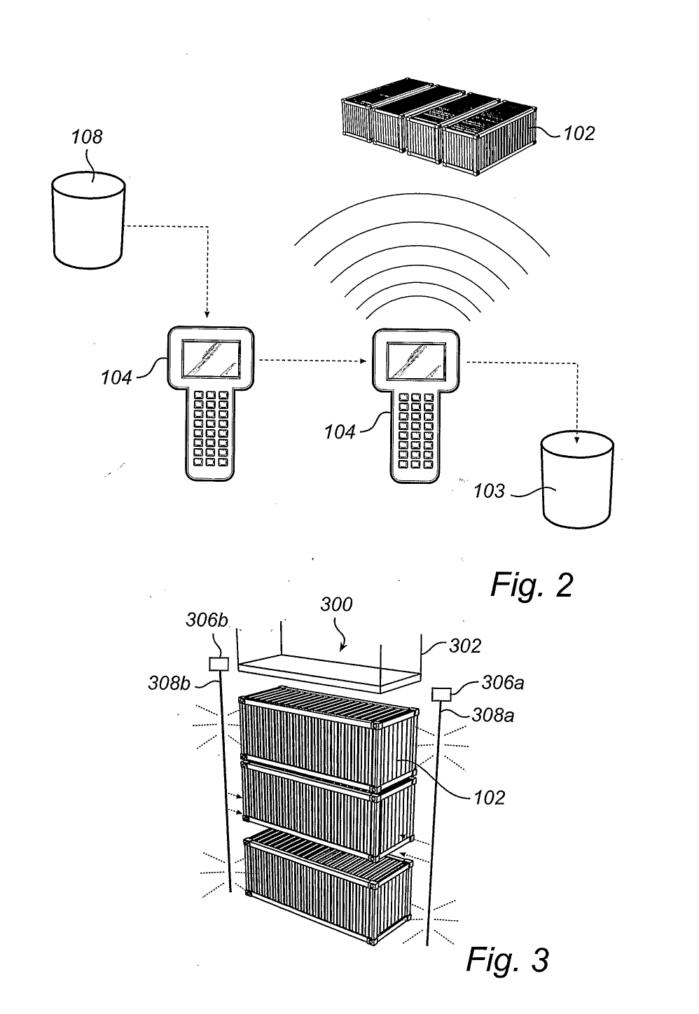

Referring now to FIG. 2, there is shown one embodiment of programming for a remotely-controlled twist-lock (RCT). As shown herein, a load plan sequence is delivered to a standard terminal hand-held computer. The container to be loaded is then selected, and the RCTs with the container are programmed with the container number. Finally, the RCT and container numbers are stored in a load database.

FIG. 3 illustrates a container-unloading scenario 300. In the scenario 300, a spreader 302 is shown unloading two containers from within a hold of a ship 304. Also shown in FIG. 3 are a reader 306a and a reader 306b. Attached to the reader 306a and the reader 306b, respectively, are leaking coaxial repeaters 308a and 308b. The leaking coaxial repeaters 308a and 308b are used to boost signals to and from the readers 306a and 306b within the hold of the ship 304. Those having ordinary skill in the art will appreciate that other methods of boosting signal between remotely-controlled twist-locks within the hold of the ship 304 may be used without departing from principles of the invention and that, in some ship-hold environments, signal boosting may not even be necessary.

As noted above, the spreader 302 is shown removing the two containers from the hold of the ship 304. The two containers remain locked together via four remotely-controlled twist-locks (not explicitly shown). Four remotely-controlled twist-locks 001-004 are shown attached to an underside of the upper container, the remotely-controlled twist-locks 001-004 having been remotely unlocked from the container lower via one or both of the readers 306a-306b and the repeaters 308a-308b.

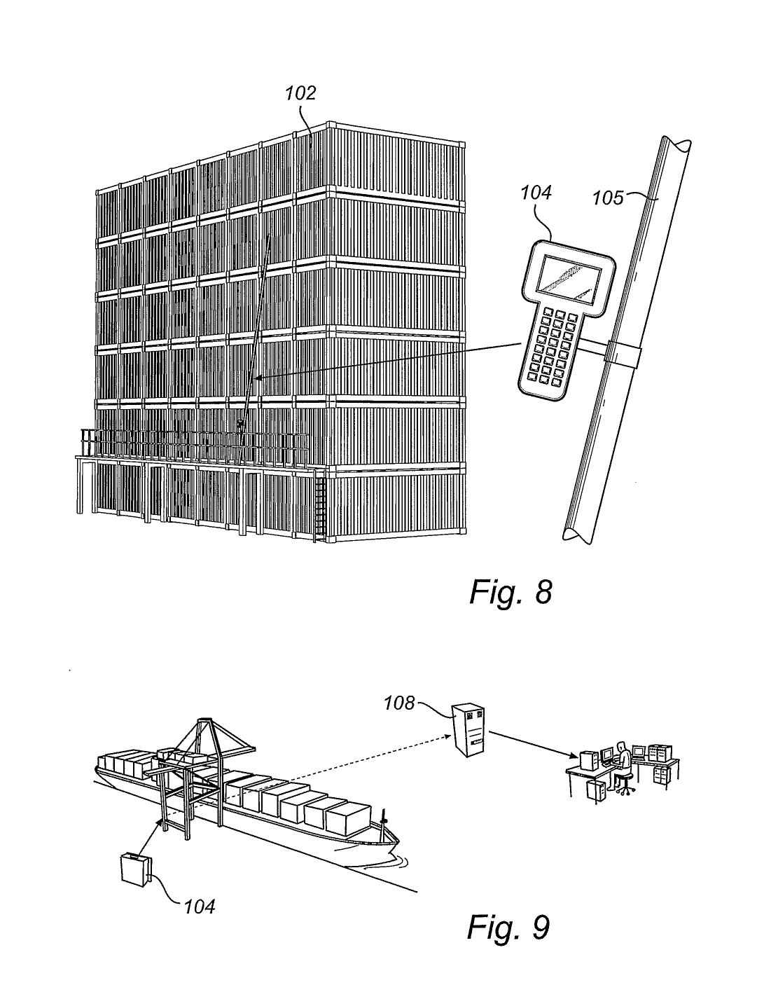

In accordance with the principles of the present invention, a remote controlled twist-lock (RCT) locking and unlocking process is shown and described. Programming of the container number into the RCT, as described above, is performed when installing the twist-locks prior to loading (coning). FIG. 2, as described above, shows the particular programming of the RCTs. Likewise, FIG. 1 illustrates the matching of the RCTs with the container, and the transmission of information to the Terminal Operating System (TOS). In accordance with one aspect of the principles of the present invention, there is shown in FIG. 8, a remote control actuator pole 105 (RCAP). The RCAP permits an antenna to be disposed on a first end while a detachable remote control unit 104 (RCU) is disposed on an opposite end. A telescoping extension between 2 to 8 meters is illustrated herein although telescoping links are clearly contemplated in accordance with the principles of the present invention.

The remote control unit 104 has a built in antenna with a range of 10m. It is further possible to detachable connect a telescopic pole with an antenna (range 30m) to the remote control unit. Still referring to FIG. 8, the antenna at the top end of the RCAP 105 provides, in this embodiment, a range of around 30 meters. This enhanced antenna range facilitates the communication between the RCU 104 and the select RCT 104a-d. This enables an individual, such as a stevedore, to position the RCAP and its antenna closer to the select RCT. This is illustrated in more detail in FIG. 8. The RCU may be constructed to receive a memory stick that may be programmed with the discharge plan of the selective containers, as well as the RCT identification information. The detachable RCU has the particular RCT identifier information so that its broadcast of the actuation signal through the antenna at the end of the RCAP 105 allows actuation to occur in the desired, selective manner.

The unlocking (actuating) processing is described in detail; Remote (electronically and wirelessly) unlocking of the twist-lock is done, for legacy fleet, from the hatch cover both for containers below deck and on weather deck. For new-build ships, this function can be built in. This is done via:
1. Remote control actuator pole 105 (RCAP) with extended reach (range >30m) or;
2. Remote control unit 104 detached (stand alone) from the RCAP 105.

Each twist-lock 104a-d with the same container number will be unlocked remotely by the RCAP 105. The RCAP gets all the container numbers to be unlocked via a memory stick that plugs in to the device. These numbers are directly extracted from the ships existing load computer, in which the “discharge plan” is created (for each port of call).

As shown therein, remote unlocking of the RCTs may be done from the hatch cover or in the manner shown in FIG. 8, referred to above. Each RCT 104a-d with the same CTR (“Container”) number will be unlocked remotely by the RCAP 105. The RCAP gets all the CTR numbers to be unlocked via a memory stick that plugs into the device. These numbers are directly extracted from the ships existing load computer in which the discharge plan is created for each port of call.

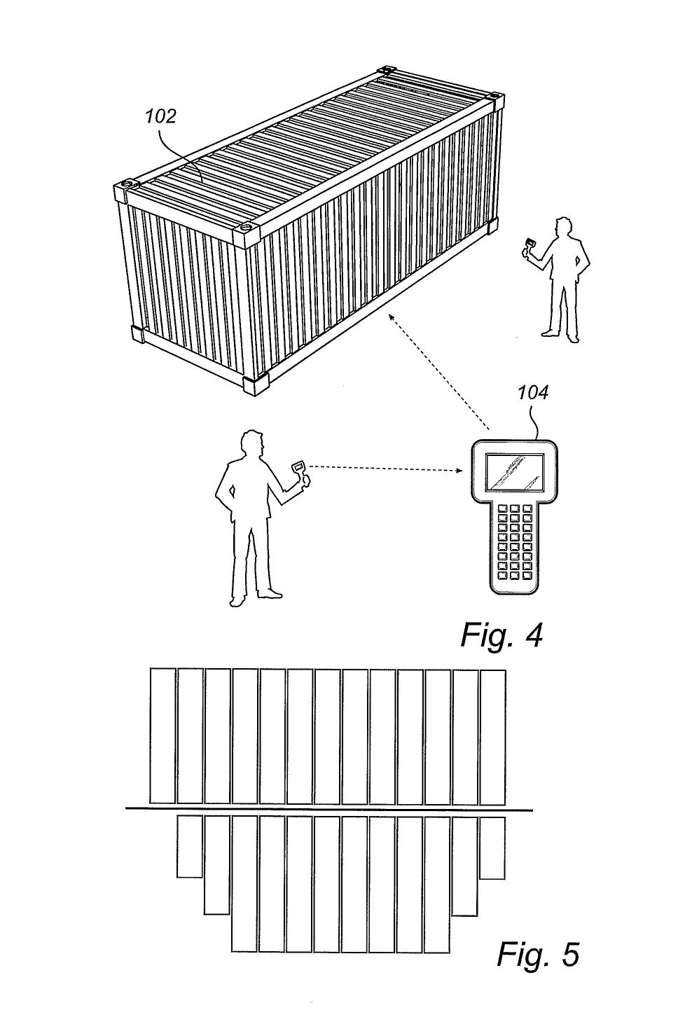

Referring now to FIGS. 4-9, various aspects of the methods of and apparatus for actuating remotely controlled twist-locks will be set forth, shown and described. In FIG. 4, the installation process is again illustratively shown wherein the programming of the container number into the RCT is done when installing the twist-locks prior to loading (coning). With this information, the location of each container and the ability to access each twist-lock for select remote actuation thereof may therein be provided through a master plan. The master plan may include a complete layout of the containers situated within the ship and the information stored on the ship's load computer. In that regard, a discharge plan may be created, which discharge plan most effectively utilizes the advantages of embodiments of the present invention.

Referring now to FIG. 5, there is shown a diagrammatical illustration of a plurality of containers stored upon a ship. In this particular view, the load master depiction illustrates a stack of containers as may be presented both beneath and above the hold of a ship viewed from a front and/or rear elevational view thereof. The discharge plan is created in the ship's load computer and comprises a list of all the container numbers to be discharged. As referenced above, the plan maybe saved on a memory stick that can be inserted into the RCU.

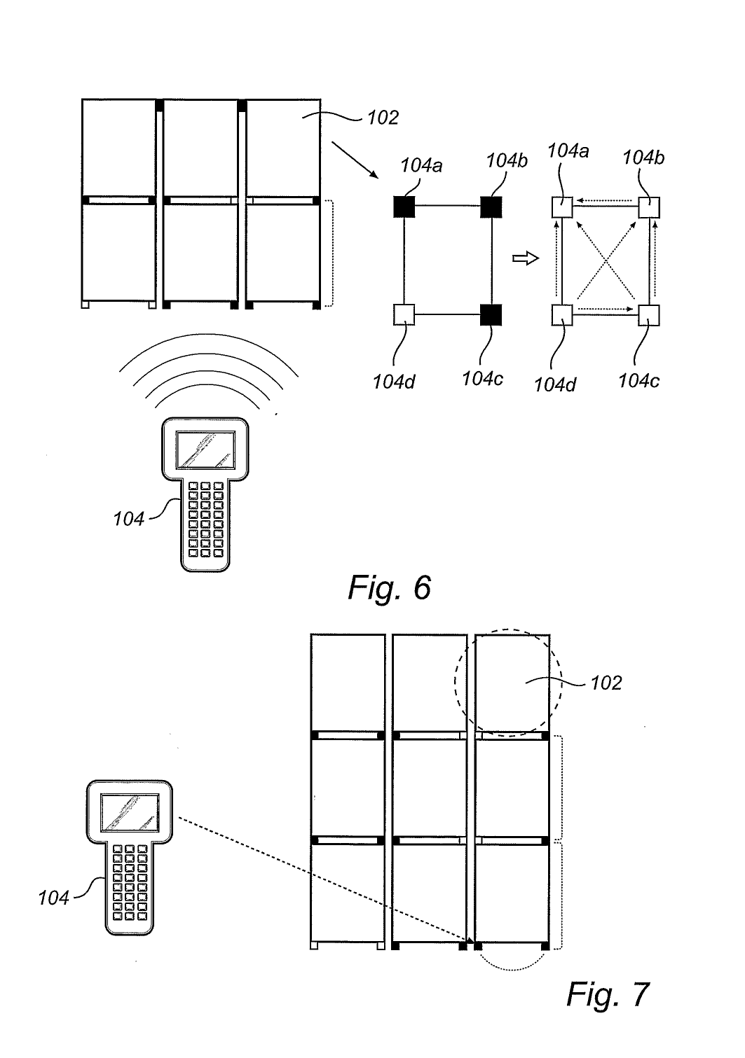

Referring now to FIG. 6, there is shown one embodiment of the present invention wherein a daisy chain approach is afforded. In this manner, access to one RCT by the RCU 104 and/or RCAP 105 will allow all RCTs of a single container therein identified to be actuated. In one embodiment of the present invention, the daisy chain may further permit communication between an RCT 104a-d at a first container 102, and an RCT of another container in communication range thereof to permit the actuation of RCTs 104a-d of more than one container 102. In that regard, the RCU 104 at the bottom of the telescoping antenna pole allows the operator to monitor the effectiveness of the communication signal and determine if the antenna has communicated correctly with the necessary container RCTs to get the right signal and communication link. It is particularly important when daisy chain actuation is involved. In that regard, the RCU 104 may be selectively programmed to indicate specifically which containers have been actuated and those which have not been, and color-coding processes or other indicia may be utilized in accordance with the principles of the present invention.

Referring now to FIG. 7, another aspect of the present invention is set forth and shown. In this embodiment, the RCU 104 contains a menu that permits the enhancement of the range to provide the daisy chaining discussed above. Such enhancement will trigger the RCTs to start the above-described daisy chaining wherein the unlock command from a first RCT is passed along from container to container until it reaches its destination. This is particularly important when containers are in areas of a ship's hold and/or above deck in a position that may be hard to communicate with, even with the RCAP 105. In accordance with certain embodiments of the present invention, a load planner for a select port, selects which containers 102 shall be discharged from a ship. This discharge plan may include the need for twin lifting, wherein more than one container is lifted at a single time, and the locking of two containers together is important to facilitate same. In such discharge plans, color coding of the RCT 104a-d as viewed by the RCU 104 will enable the operator to confirm appropriate actuation of the RCT through the RCAP 105 in accordance with the discharge plan to allow the select unloading in the most efficient manner. It may be seen that these actuation steps are facilitated without any manual engagement of the twist-locks 104a-d, and such problems associated with such manual access is substantially eliminated.

Referring now to FIG. 8, a stevedore is shown accessing RCTs 104a-d by the utilization of an RCU 104 assembled in conjunction with an RCAP 105. The RCU 104 is seen to be removable from the RCAP 105, in one embodiment, and an antenna-connector is provided for such connection and disconnection.

Referring now to FIG. 9, the overall view of the terminal operating system 108 (TOS), load planner and a reader 104 installed on the spreader is diagrammatically illustrated. This particular view is also set forth and shown in co-pending provisional patent application No. 60/607,179 incorporated herein by reference and set forth and described above. Consistent therewith, FIG. 9 diagrammatically illustrates a loading process in accordance with certain principles of the invention. As set forth herein, a reader is shown installed on the spreader, as the spreader is loading inter-modal containers on a ship. After matching of RCTs 104a-d to the respective container being loaded, matching data is forwarded by the reader 104 to a remote server and/or terminal operating system 108 (TOS). The TOS 108 and the data contained therein may be accessed by a load planner in order to obtain the most efficient and cost effective loading of the ship by the spreader 302. Likewise, this information is utilized in the discharge plan of the containers as described above.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. A method for controlling a twist-lock (104a-d) to be connected to a container (102) for locking two containers together
characterized in the steps of:
matching the remotely controlled twist-lock (104a-d) with the container (102), wherein unique identifiers are registered for said twist-lock and said container,
storing said identifier information in a database.

2. A method according to claim 1, further comprising the step of:
selectively remote unlocking of the twist-locks (104a-d) for unlocking of the containers (102) from each other.

3. A method according to any of the preceding claims, further comprising the step of:
entering data to said database to be associated with said identifier, for example the loaded weight of said container (102).

4. A method according to any of the preceding claims, further comprising the step of:
programming a security device (106), to be mounted on the container (102), with the identifiers of said twist-lock (104a-d).

5. A method according to claim 4, further comprising the step of:
transmitting identifiers from said twist-lock (104a-d) and said security device (106) to a remote server.

6. A method according to any of the preceding claims, further comprising the step of:
creating a discharge plan to be saved on a memory stick and used by a remote control unit (104) for controlling said twist-lock (104a-d).

7. A method according to any of the preceding claims, further comprising the step of:
daisy chaining wherein the unlock command from a first twist-lock (104a-d) is passed along from container to container until it reaches its destination.

8. A twist-lock (104a-d) for connection to a container for locking two containers (102) together, characterized in that the unlocking function of said twist-lock (104a-d) is remotely controllable by means of a remote control unit (104).

9. A twist-lock (104a-d) according to claim 8, wherein said twist-lock is provided with an identifier to be associated with an identifier of the container (102).

10. A twist-lock (104a-d) according to any of the claims 8-9, wherein a particular twist-lock is identifiable, which permits selective remote unlocking of the twist-lock (104a-d) via a radio interface.

11. A twist-lock (104a-d) according to any of the claims 8-10, wherein said remote control unit (104) is connectable to a antenna (105) for enhancing the communication between said twist-lock and said remote control unit.

12. A twist-lock (104a-d) according to any of the claims 8-11, wherein said twist-lock is flangeless, i.e. without adding unnecessary vertical height between the containers.
